(19) United States
(12) Patent Application Publication
(10) Pub. No.: US 2024/0376620 A1
(43) Pub. Date: Nov. 14, 2024

(54) METHOD FOR OPERATING AN ELECTROLYSIS PLANT, AND ELECTROLYSIS PLANT

(71) Applicant: Siemens Energy Global GmbH & Co. KG, München (DE)

(72) Inventors: Erik Wolf, Röttenbach, (DE); Udo Reckels, Neuss (DE); Stefan Braun, Neukirchen-Vluyn (DE); Thomas Bielmeier, Berlin (DE)

(21) Appl. No.: 18/566,160

(22) PCT Filed: Mar. 4, 2022
(86) PCT No.: PCT/EP2022/061963

§ 371 Date: Jul. 25, 2024

(30) Foreign Application Priority Data
Jun. 24, 2021 (EP) 21181396.9

(51) Int. Cl. C25B 15/023; C25B 1/04; C25B 15/021; C25B 15/08

(52) U.S. Cl. CPC C25B 15/023; C25B 1/04; C25B 15/021; C25B 15/08

(57) ABSTRACT

The invention relates to a method for operating an electrolysis plant having an electrolyser for generating hydrogen and oxygen as product gases, and a control unit. At least the hydrogen product gas, which also contains oxygen as an external gas, is compressed. According to the invention, the energy required in the purification of the foreign gas in the product gas of the electrolysis plant can be reduced by making optimum use of the heating of the product gas by the compression process, whereby the hydrogen product gas is subsequently fed to a recombiner which contains a catalyst in which the oxygen recombines with the hydrogen to form water. The invention also relates to an electrolysis plant designed for efficient product gas purification, by means of which hydrogen purified from oxygen as an impurity gas can be produced as a product gas.

The invention relates to a method for operating an electrolysis system comprising an electrolyzer for generating hydrogen and oxygen as product gases and also a control unit. The invention further relates to such an electrolysis system.

Nowadays, hydrogen is generated for example by means of proton exchange membrane (PEM) electrolysis or alkaline electrolysis. Electrolyzers use electrical energy to produce hydrogen and oxygen from the water supplied. This process takes place in an electrolysis stack composed of two or more electrolysis cells. In the electrolysis stack, to which a DC voltage is applied, water is introduced as reactant, with two fluid streams consisting of water and gas bubbles (O₂ and H₂) exiting after passing through the electrolysis cells.

In practice, small amounts of hydrogen are located in the oxygen gas stream and small amounts of oxygen are located in the hydrogen gas stream. The quantity of the respective extraneous gas depends on the design of the electrolysis cells and also varies under the influence of the current density, catalyst composition, ageing and, in the case of a PEM electrolysis system, the membrane material. It is an inherent feature of the system that the gas stream of one product gas contains very small amounts of the respective other product gas. The oxygen traces are generally removed from the hydrogen in the further course of the process, especially when a high product gas quality is required, as is the case when using the hydrogen for fuel cells, for example.

In order to solve the problem described above, both product gas streams are fed in particular to a respective, catalytically activated recombiner, in which a catalyst allows the hydrogen to recombine with the oxygen to form water. To this end, the gas stream needs to be heated to at least 80° C. beforehand in order for the conversion rates in the recombiner to be sufficiently high and for the required gas purity to thus be achieved. However, the industrial system used for this is expensive and on account of its energy requirement reduces the system efficiency of the electrolysis system, which in turn results in increased operational expenditure.

The object of the invention is therefore that of making it possible to reduce the energy requirement for clearing the extraneous gas from a product gas of an electrolysis system.

The object is achieved according to the invention by a method for operating an electrolysis system comprising an electrolyzer for generating hydrogen and oxygen as product gases and also a control unit, wherein at least the hydrogen product gas, which also contains oxygen as extraneous gas, is compressed and the hydrogen product gas is then fed to a recombiner which contains a catalyst and in which the oxygen recombines with the hydrogen to form water, wherein a pressure and a temperature are determined both at the inlet and at the outlet of the recombiner and the measured values determined are processed in the control unit, and wherein the determined pressure and the determined temperature are compared with a respective reference value in the control unit, and wherein if the reference value is exceeded a bypass conduit is opened through which at least a portion of the compressed product gas is guided past the recombiner.

The object is also achieved according to the invention by an electrolysis system comprising an electrolyzer for generating hydrogen and oxygen as product gases and also a control unit, wherein the hydrogen product gas also contains oxygen as extraneous gas, wherein a product stream conduit is provided for the hydrogen product gas, wherein a compressor is installed in the product stream conduit, wherein connected downstream of the compressor is a recombiner which contains a catalyst for the recombination of the oxygen with the hydrogen to form water, and wherein measurement devices for pressure and temperature measurement are arranged at the inlet and at the outlet of the recombiner, wherein the control unit is configured to process the measurement signals and to compare the determined pressure and the determined temperature with a respective reference value and, if the reference value is exceeded, to open a bypass conduit through which at least a portion of the compressed product gas can be guided past the recombiner.

The advantages and preferred embodiments mentioned below in relation to the method can be transposed correspondingly to the electrolysis system.

The electrolyzer is designed here for PEM electrolysis or for alkaline electrolysis.

The control unit serves to gather and evaluate parameters and optionally control components of the electrolysis system.

Many applications in electrolysis require the product-side gas pressure to be increased. Low-pressure electrolysis in particular requires further gas compression. Piston compressors are especially used for this purpose. The heat generated by the compression process and the associated increase in temperature of the product gas are exploited by the invention in a controlled manner. At the same time, a pressure and a temperature at the inlet and at the outlet of the recombiner are determined and the determined measured value is processed in the control unit. Detection of the operating parameters of the product gas enables monitoring and optionally control of the conversion rate and further performance parameters, and also safe and disruption-free operation with high reliability, meaning that overheating of the catalyst is prevented in particular. As a result of the compression, therefore, the gas temperature of the hydrogen product gas is brought to a desired temperature level of greater than around 80° C. in a controlled manner, and the temperature is monitored via the control unit and kept at this value as far as possible, in order to thermally activate the catalyst while at the same time not overheating it. This allows the process of oxygen removal to be conducted in a downstream recombiner that contains platinum or rhodium, for example, as catalytically active material, so that the catalytic recombination is initiated and sustained stably in operation. The essential advantage of this is that the recombiner does not require any additional supply of heat in order for the catalytic recombination to be able take place, and instead the heating of the product gas by the compression process itself is used optimally and in a specific manner for the catalytic clearing of extraneous gas.

Consequently, in a preferred embodiment of the method, the compression results in the temperature of the hydrogen product gas being increased and brought to a temperature level of greater than 80° C., so that the catalytic recombination is brought about by the compression-induced supply of heat, with the recombination process being sustained in a controlled manner.

The recombination catalyst is pressure-and pulsation-resistant in design. The recombiner is in particular integrated within the compressor or connected immediately downstream of the compressor, and can be adjusted with respect to the ideal pressure level. Space and costs are thus saved.

With regard to a further increase in the quality of purification from extraneous gas, preferably a two-stage or multistage compression is used and the recombination is carried out after at least two compression stages, in particular the recombination is carried out after each of the compression stages. The recombination catalyst is integrated after the outlet valve and before an intercooler or a cooler of the last compressor stage.

The recombination of the H₂/O₂ mixture to form H₂O takes place in an exothermic reaction. The end temperature rises with higher proportions of O₂ in the H₂ and possibly has to be limited. The product gas is therefore preferably cooled immediately after the recombiner or within the recombiner.

The cooling is preferably effected by addition of water and/or hydrogen. Cost-effective and technically easily implementable cooling is possible in this way, since both water and hydrogen are available in the electrolysis system.

According to a preferred embodiment, during the cooling of the product gas at least a portion of the water vapor present in the product gas condenses and the condensate is fed into the electrolyzer. The cooling apparatus connected downstream of the recombiner serves not only to condition the gas temperature for the following compressor stage/the following process step, but is additionally designed to condense a portion of the water vapor present in the gas. This condensate is reused by feeding it to the electrolysis system, for example in order to reduce the requirement for electrolysis water.

Alternatively or in addition to this, preferably the temperature of the condensate is determined and is processed in the control unit.

Preferably, the determined pressure and the determined temperature are compared with a respective reference value in the control unit, and if the reference value is exceeded a bypass conduit is opened through which at least a portion of the compressed product gas is guided past the recombiner. A portion of the gas stream is not treated in this case, which has an effect on the heat released. The outlet temperature is controlled in a simple manner as a result.

Advantageously, the catalyst, for example platinum or rhodium, has been applied to a ceramic support and/or a metallic support. The degree of purity of the product gas can be adjusted via the catalyst volume.

Exemplary embodiments of the invention are elucidated in more detail with reference to a drawing. In the drawing, schematically and in a highly simplified manner:

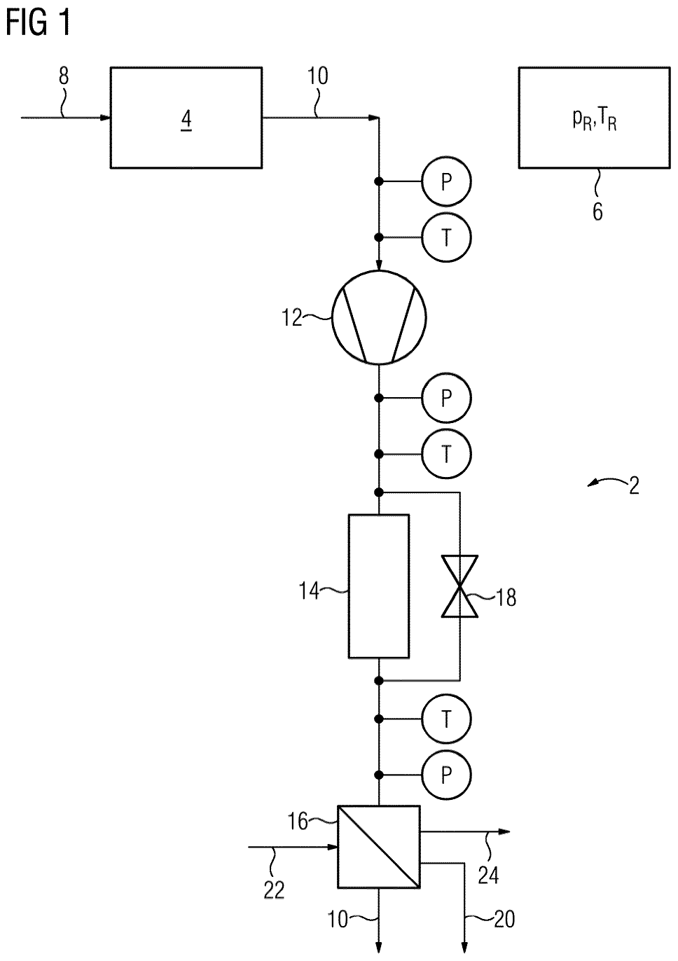

FIG. 1 shows an electrolysis system with a hydrogen-side single-stage compressor, and

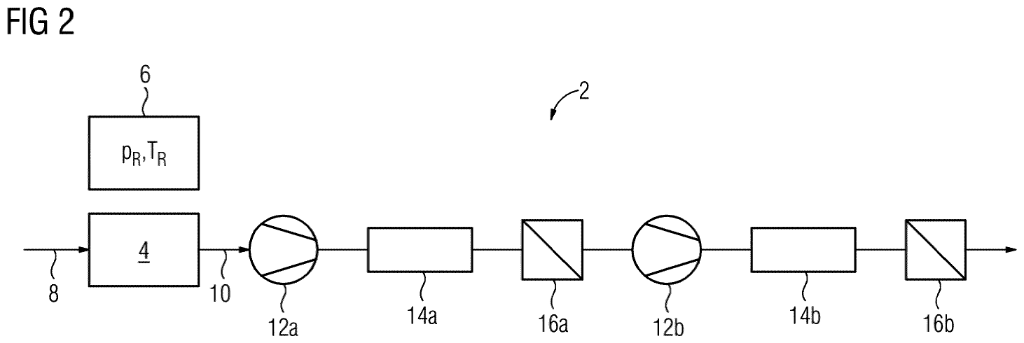

FIG. 2 shows an electrolysis system with a hydrogen side multistage compressor.

Identical reference signs have an identical meaning in the figures.

FIG. 1 shows an electrolysis system 2 with a PEM or alkaline electrolyzer 4. The electrolyzer 4 comprises at least one electrolysis cell (not shown in more detail here) for decomposing water. The electrolysis system 2 also has a control unit 6, depicted symbolically in the figure. The control unit 6 controls components of the electrolysis system 2 depending on various stored, calculated or detected parameters.

In the electrolyzer 4, a reactant stream of water is introduced via a reactant stream conduit 8. The water is decomposed in the electrolyzer 4 into the product gases hydrogen and oxygen, and both product streams are guided out separately. To this end, the electrolyzer 4 has a product stream conduit 10 by means of which a first product, hydrogen here, is guided out. The construction described below relates to the hydrogen product stream, but the same construction can be present on the oxygen side.

The hydrogen product gas in the product stream conduit 10 contains oxygen impurities that must be removed. To this end, the hydrogen product stream is first compressed in a compressor 12 to increase its temperature to over 80° C. Immediately thereafter, the heated hydrogen product stream is fed to a recombiner 14 that contains platinum or rhodium as catalyst material. The recombiner 14 can also be integrated in the compressor 12. The catalyst has been applied to a ceramic or metallic support. In the recombiner 14, the catalyst allows the hydrogen to recombine with the oxygen to form water. The product stream is then cooled in a cooling apparatus 16 since the reaction in the recombiner 14 proceeds exothermically. The cooling is effected by addition of water and/or hydrogen though a cooling conduit 22. The cooling medium then leaves the cooling apparatus 16 through the conduit 24.

Alternatively, the cooling can also take place in the recombiner 14, meaning that the cooling apparatus 16 is integrated in the recombiner 14.

In order to control the recombination process, in the exemplary embodiment shown a pressure p and a temperature T of the product gas are detected both at the inlet and at the outlet of the recombiner 14 via appropriate measurement devices for pressure p and temperature T and are fed to the control unit 6. In the control unit 6 the determined actual values are monitored in particular with regard to exceedance of a respective reference value p_{R}, T_{R}. In the event of a deviation from the permissible operating parameters, a bypass conduit 18 is opened which guides at least a portion of the compressed product gas past the recombiner 14. This brings about a stable and disruption-free operation of the recombiner 14 and in particular prevents overheating of the catalyst, in particular if the reference value T_{R} for the temperature T is exceeded.

During cooling of the hydrogen product stream, at least a portion of the water vapor present in the gas condenses and the condensate is fed to the electrolyzer 4 via a return conduit 20.

The second exemplary embodiment according to FIG. 2 differs essentially in that a multistage compression is carried out. Accordingly, two compressor stages 12a and 12b are installed. A respective recombiner 14a, 14b and a respective cooling apparatus 16a, 16b are connected downstream of each of the compressor stages 12a, 12b. The respective temperature measurement point and the pressure measurement point before the recombiner 14a, 14b and after the recombiner 14a, 14b are not specifically illustrated here in the schematic illustration of FIG. 2. However, these measurement devices are fitted to the product stream conduit 10 of the electrolysis system 2 at the entry and at the exit of the recombiner 14a, 14b, analogously to in FIG. 1.

1. A method for operating an electrolysis system (2) comprising an electrolyzer (4) for generating hydrogen and oxygen as product gases and also a control unit (6), wherein at least the hydrogen product gas, which also contains oxygen as extraneous gas, is compressed and the hydrogen product gas is then fed to a recombiner (14, 14a, 14b) which contains a catalyst and in which the oxygen recombines with the hydrogen to form water, wherein a pressure (p) and a temperature (T) are determined both at the inlet and at the outlet of the recombiner (14, 14a, 14_{b}) and the measured values determined are processed in the control unit (6), and wherein the determined pressure (p) and the determined temperature (T) are compared with a respective reference value (P_{R}, T_{R}) in the control unit (6), and if the reference value (P_{R}, T_{R}) is exceeded a bypass conduit (18) is opened through which at least a portion of the compressed product gas is guided past the recombiner (14, 14a, 14_{b}).

2. The method as claimed in claim 1, wherein the compression results in the temperature of the hydrogen product gas being warmed and brought to a temperature level of greater than 80° C., so that the catalytic recombination is brought about by the supply of heat.

3. The method as claimed in claim 1 or 2, wherein a two-stage or multistage compression is used and the recombination is carried out after at least two compression stages (12a, 12_{b}), in particular is carried out after each of the compression stages.

4. The method as claimed in any of the preceding claims, wherein the product gas is cooled immediately before or after the recombiner (14, 14a, 14_{b}) or within the recombiner (14, 14ₐ, 14_{b}).

5. The method as claimed in claim 4, wherein the cooling is effected by addition of water and/or hydrogen.

6. The method as claimed in claim 4 or 5, wherein during the cooling of the product gas at least a portion of the water vapor present in the product gas condenses and the condensate is fed into the electrolyzer (4).

7. The method as claimed in claim 6, wherein the temperature of the condensate is determined and is processed in the control unit (6).

8. The method as claimed in any of the preceding claims, wherein the catalyst has been applied to a ceramic support and/or a metallic support.

9. An electrolysis system (2) comprising an electrolyzer (4) for generating hydrogen and oxygen as product gases and also a control unit (6), wherein the hydrogen product gas also contains oxygen as extraneous gas, wherein a product stream conduit (10) is provided for the hydrogen product gas, wherein a compressor (12, 12a, 12_{b}) is installed in the product stream conduit (10), and wherein connected downstream of the compressor (12, 12ₐ, 12_{b}) is a recombiner (14, 14a, 14_{b}) which contains a catalyst for the recombination of the oxygen with the hydrogen to form water, and wherein measurement devices for pressure and temperature measurement are arranged at the inlet and at the outlet of the recombiner (14, 14a, 14_{b}), wherein the control unit (6) is configured to process the measurement signals (p, T) and to compare the determined pressure (p) and the determined temperature (T) with a respective reference value (P_{R}, T_{R}) and, if the reference value (P_{R}, T_{R}) is exceeded, to open a bypass conduit (18) through which at least a portion of the compressed product gas can be guided past the recombiner (14, 14a, 14_{b}).

10. The electrolysis system (2) as claimed in claim 9, which comprises a two-stage or multistage compressor (12a, 12_{b}) and a recombiner (14a, 14_{b}) is provided in each case after at least two compression stages, in particular a recombiner (14a, 14_{b}) is provided after each of the compression stages.

11. The electrolysis system (2) as claimed in claim 9, in which a cooler apparatus (16, 16a, 16_{b}) for cooling the product gas is installed before or after the recombiner (14, 14a, 14_{b}) or within the recombiner.

12. The electrolysis system (2) as claimed in claim 11, wherein the cooler apparatus (16, 16a, 16_{b}) is designed for addition of water and/or hydrogen as coolant via a cooling conduit (22).

13. The electrolysis system (2) as claimed in claim 11 or 12, wherein the cooler apparatus (16, 16a, 16_{b}) is designed for at least partial condensation of the water vapor present in the product gas and a return conduit (20) for the condensate is provided, which opens into the electrolyzer (4).

14. The electrolysis system (2) as claimed in claim 13, wherein a further measurement device is provided for determining the temperature of the condensate, and the control unit (6) is configured to process the measurement signal from the further measurement device.

15. The electrolysis system (2) as claimed in any of claims 9 to 14, wherein the catalyst has been applied to a ceramic support and/or a metallic support.
